(19) United States
(12) Patent Application Publication
(10) Pub. No.: US 2008/0168872 A1
(43) Pub. Date: Jul. 17, 2008

(54) METHOD AND DEVICE FOR MILLING WAX MODELS

(75) Inventor: Alexander Frederik LENNINGS, Utrecht (NL)

Correspondence Address: OBLON, SPIVAK, MCCLELLAND MAIER & NEUSTADT, P.C., 1940 DUKE STREET, ALEXANDRIA, VA, 22314, US

(73) Assignee: DELFT SPLINE SYSTEMS, Utrecht (NL)

(21) Appl. No.: 11/971,453

(22) Filed: Jan. 9, 2008

(30) Foreign Application Priority Data
Jan. 12, 2007 (NL) NL-1033220

(51) Int. Cl. B26D 5/20; B26D 5/08; B23Q 3/02

(52) U.S. Cl. 83/76.8; 83/565; 269/93; 83/76.6

(57) ABSTRACT

A method is provided wherein a wax-like starting material is worked to obtain a prototype of an ornament, such as a ring, which working of the starting material takes place while the starting material is fixed in place on a manipulable holding fixture. The operations are carried out in at least one Cartesian coordinate (x,y,z) direction as well as in at least one cylinder coordinate (x,r,φ) direction, while the starting material is fixed in place on the same holding fixture. This procedure makes the method easier and quicker to carry out, and permits the production numbers therefore to increase, while decreasing the cost price per product.

### BACKGROUND OF THE INVENTION

1. Field of the Invention

The present invention relates to a method wherein a starting material is worked to obtain a prototype of an ornament, which working of the starting material takes place while the starting material is fixed in place on a manipulable holding fixture.

The present invention further relates to a device for forming a prototype of an ornament from a starting material, which device comprises a holding fixture, on which the starting material can be fixed in place, and working means for working the starting material while it is fixed in place on the holding fixture, which device also relates to a holding fixture and to software for carrying out said method.

2. Background of the Disclosure

Such a known method is used for clamping down a wax-like starting material on a manipulable, i.e. also positionable and rotatable, drivable holding fixture and working said starting material, for example by means of a milling cutter so as to form a wax model as a prototype for an ornament, such as a ring. The model is further used for making a casting mold for forming the ornament by means of the so-called lost wax method.

The drawback of the known method and device is the fact that it is difficult to carry out advanced operations, for example along different coordinate axes or with undercuts, in a simple manner.

### SUMMARY OF THE INVENTION

The object of the present invention is to provide a universally applicable method which makes it possible to carry out operations with more than one degree of freedom, so that a more varied range of ornaments can be made, also by non-professionals, using a device which is not normally suitable for that purpose.

In order to accomplish such object, the method according to the invention is characterized in that the operations are carried out in at least one Cartesian coordinate (x,y,z) direction as well as in at least one cylinder coordinate (x,r,φ) direction, while the starting material is fixed in place on the same holding fixture.

Accordingly, the device according to the invention is characterized in that the holding fixture has at least two mutually perpendicular clamping surfaces.

The advantage of the method and the device according to the invention is that, irrespective of the direction in which the block of starting material, usually a soft, workable material such as wax, that is being worked, it is still possible to use the same holding fixture. Thus it is possible, if the ornament is a ring, for example, to work one side thereof, after which the other side can be worked, followed by operations on the circumference of the ring. When operations are combined, it is possible even to realize undercuts. One and the same holding fixture can be used for all the operations, which makes the method easier and quicker to carry out, as a result of which production numbers will increase while the cost price per product will decrease.

Furthermore advantageous is the fact that since one holding fixture is used for all the operations, each of said operations can be carried out from the same zero point or reference point. This increases the level of accuracy with which the operations are carried out, as a result of which higher degrees of accuracy are achieved not only with one and the same ornament, but also the degree of accuracy and precise dimensioning of different ornaments between themselves will increase, in particular between ornaments of the same type.

In principle it is moreover possible to use the same working element, or the same milling cutter, for carrying out the necessary operations on the starting material. Furthermore, preliminary operations and finishing operations can be carried out while the starting material is fixed in place on one and the same holding fixture. This reduces the time required for working and handling the material and furthermore has a positive effect on the accuracy of the final product when carrying out these operations.

One embodiment of the device according to the present invention is characterized in that the fixing means comprise pins and holes corresponding at least with one another, thereby making it possible to clamp down or place and remove the block of starting material to be worked in a simple manner, while it becomes possible to work with close tolerances.

The pins and holes are preferably arranged eccentrically relative to the centre of the ornament, so that the material can be placed on the holding fixture only in one way, rendering incorrect placement impossible.

Furthermore preferably, the pins and holes are disposed within the ornament, so that fixation and clamping down of the block of material will take place from the inside rather than from the outside. A block of wax can thus be the same size as the ring to be formed, so that no material, which would otherwise be needed to enable circumferential clamping, will be lost. This saves material, while less time is needed for additional operations along the circumference of the material.

Further advantageous embodiments of the method and the device are defined in the other claims.

### BRIEF DESCRIPTION OF THE DRAWINGS

The method, the device, the holding fixture and the control software according to the present invention will now be explained in more detail with reference to the figures below, in which like parts are provided with the same numerals. In the drawing:

FIG. 1 shows a holding fixture for use with the method and device according to the invention, in which starting material to be worked is fixed in place on the end surface of the fixture; and

FIG. 2 shows the holding fixture of FIG. 1, in which the starting material is fixed in place on a lateral long side of the fixture.

### DESCRIPTION OF THE PREFERRED EMBODIMENTS

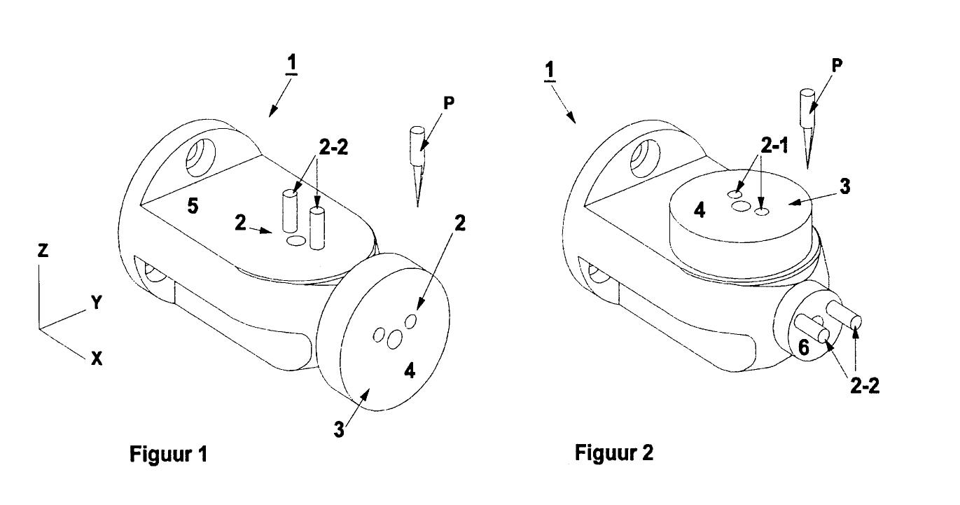

FIG. 1 shows a holding fixture 1, on which a soft starting material 3 to be worked is fixed in place by fixing means, for the time being generally indicated at 2. The starting material is usually a wax or a relatively soft plastic, and in said material 3 a pattern or shape is formed, using schematically indicated working means P such as coarse or fine milling cutters or drills having a desired shape, so that a prototype having a desired three-dimensional shape is formed. The word ‘prototype’ as used in the present application is to be understood to mean not only a test model, which precedes a production model, but also a parent model that is used in the production of an end product, and said model may even be the end product itself which is formed directly, for example when working gold. The desired pattern may be the pattern of a medallion, a ring or another ornament, for example. The prototype of a ring, for example, is formed by means of one or more of milling cutters while it is fixed in place on the holding fixture 1. The holding fixture 1 is manipulated during said working, which manipulation may take place manually, but in practice it is usually carried out mechanically in view of the required dimensional precision.

In the present method for manufacturing the prototype, the operations are carried out in at least one Cartesian coordinate (x,y,z) direction as well as in at least one cylinder coordinate (x,r,φ) direction, while the starting material is fixed in place on the same holding fixture. Other holding fixtures or auxiliary means are not needed. For example, a flat side 4 of the starting material 3 can be worked in one or more of the x,y,z directions while the material is fixed in place on a first flat clamping side 5 of the holding fixture 1. After the cylindrical (in the present case) block of material 3 has been turned over, the other flat side opposite the aforesaid one flat side 4 can be worked in one or more of the x,y,z directions, if desired. The holding fixture 1, which can be moved or manipulated by means not shown in the figures, has one or more flat clamping sides, such as the lateral clamping side 5, on which the material 3 can be fixed in place while one of the flat sides thereof is being worked, in particular with a milling cutter P.

The holding fixture 1 has a short end clamping surface 1 side, which extends perpendicularly to the at least one flat clamping side 5 of the holding fixture 1, which clamping surface 6 extends vertically in a practical arrangement, while the clamping side 5 preferably extends horizontally in that case. If the starting material is fixed in place on the same holding fixture 1, the material can be worked in at least one of the cylinder coordinate directions (x,r,φ).

The fixing means 2 comprise holes 2-1 and corresponding pins 2-2. In the illustrated embodiments, two pins 2-2 are (to be) arranged on at least one flat clamping side 5. In that case two holes 2-1 have been formed in the starting material 3, preferably during a preliminary operation already, because in that case extensive preparation prior to the actual operations is not necessary. The corresponding holes 2-1 are arranged off-center in the starting material 3, so that the material is locked against rotation during the working operations as a result of said asymmetric position. In addition, if the material 3 to be worked is incorrectly positioned on the pins 2-2, this will not go unnoticed, because part of the material will conspicuously project outside the contours of the holding fixture 1 in that case. The holes 2-1 in the material 3 have preferably been pre-drilled at a position that is already known to the software (yet to be explained), so that, as already noted before, the working operations can be started without much preparation being required. For production reasons, two or more of the clamping surfaces 5 and 6 are preferably provided with identical fixing means 2 for fixing the starting material to be worked. The sectional shape of the pins/holes 2 may be polygonal, if desired, for example triangular. Furthermore, a hole for a pin may be provided in at least one of the clamping surfaces 5, 6 on the central axis of the starting material 3. If the pin is provided with screw thread, a low-vibration fixation of the material on the surfaces 5, 6 can be realized by means of a nut to be screwed onto said pin.

The fixing means 2 are preferably arranged within the prototype of the ornament to be produced rather than on the circumference thereof, so that less material 3 is needed and no additional operations need to be carried out on the circumference of the material 3 for smoothing away any blemishes resulting from the clamping down of the material on the circumference thereof.

The operations on the fixed starting material 3 in the various Cartesian and the cylinder coordinate directions are carried out by software-controlled working means, whilst the material is fixed in place on the same one holding fixture 1. The starting point for the software is that of a 3D CAD model, for example in the form of so-called STL files, having the geometry of the ornament or ring to be produced is available. Using a so-called Wizard, the software retrieves a number of basic data, for example data regarding the axis of rotation and the other axis orientations, the dimensions of the block of wax, at least the inner diameter of the ring insofar as the outer diameter is automatically recognized, the type of milling cutter, and the spacing between the milling paths in connection with the required precision. It is possible to configure the Wizard, within the framework of which configuration it is possible to define questions that are to be adapted. Generally, the software uses a Wizard which comprises questions to be configured by the user in dependence on the type of holding fixture so as to collect the basic data needed to make it possible to carry out the operations on the block of wax present thereon.

The software then generates at least one control program which comprises instructions for controlling the material-removing working means P in at least one direction, generally in all three Cartesian coordinate directions. The control program concerns the operations on the material 3 on a flat side of said material 3. Because of the maximum flat support of the block of material on the flat clamping side 5 of the holding fixture during the first operation, in which comparatively much material is removed, vibration of the prototype will nevertheless be minimal. A similar control program is generated for the situation in which the other flat side of the material is worked while said material is fixed in place on one of the clamping surfaces 5 the same holding fixture. Furthermore, another control program is generated, which includes the instructions for controlling the working means comprising at least one milling cutter in at least one pole coordinate direction, generally both pole coordinate directions, even more generally all cylinder coordinate directions. Said control programs, which are generally incorporated in so-called NC files, can each function from the same zero point or reference point function, and thus more efficiently, with the advantage of achieving a high level of precision of the operations and of the end product. After all, one and the same holding fixture 1 can be used, on which the starting material 3 to be worked is fixed in place, in this case by means of pin-hole connections.

1. A method wherein a starting material is worked to obtain a prototype of an ornament, which working of the starting material takes place while starting material is fixed in place on a manipulable holding fixture, which comprises carrying out operations in at least one Cartesian coordinate (x,y,z) direction as well as in at least one cylinder coordinate (x,r,φ) direction, while fixing the starting material in place on the holding fixture.

2. A method according to claim 1, which comprises working the starting material in the Cartesian coordinate (x,y,z) direction while fixing the starting material in place on at least one longitudinal clamping surface of the holding fixture.

3. A method according to claim 1 or 2, which comprises working at least one flat side of the starting material.

4. A method according to any one of the claims 1-3, which comprises working the starting material in the at least one cylinder coordinate (x,r,φ) direction while fixing the starting material in place on an end surface of the holding fixture which extends perpendicularly to said at least one longitudinal clamping surface of the holding fixture.

5. A method according to any one of the claims 1-4, which comprises fixing the starting material in place by pins extending into corresponding holes of the starting material.

6. A method according to any one of the preceding claims, which comprises using a software controlled device configured to carry out the working of the fixed starting material in the at least one Cartesian coordinate direction and the at least one cylinder coordinate direction.

7. A method according to claim 6, wherein said device for carrying out the working of the starting material comprise at least one milling cutter, by means of which the preliminary and/or finishing operations on the starting material are carried out.

8. A device for forming a prototype of an ornament from a starting material, which comprises:
a holding fixture, on which the starting material can be fixed in place, and a working device configured for working the starting material while the starting material is fixed in place on the holding fixture, wherein said holding fixture has at least two mutually perpendicular clamping surfaces.

9. A device according to claim 8, wherein the holding fixture has at least two opposite clamping surfaces.

10. A device according to claim 8, wherein said clamping surfaces have identical fixing devices configured for fixing the starting material to be worked.

11. A device according to claim 10, wherein said fixing device comprise pins and/or holes corresponding with at least with one another, said pins and holes being arranged eccentrically relative to the a center portion of the ornament or within the ornament.

12. A device according to claim 8, wherein the starting material comprises a soft, workable wax-like material and the starting material is provided with predrilled fixing holes.

13. A holding fixture suitable for use in the device according to claim 8 when using the method according to claim 1, wherein said holding fixture has at least two mutually perpendicular clamping surfaces.

14. A holding fixture according to claim 13, wherein the end surface is provided with a fixing device configured for fixing the ring in a vertical position while a wax model for rings is being worked.

15. Software suitable for use with the method according to claim 1, wherein said software generates at least one control program comprising instructions for controlling a working device in at least one Cartesian coordinate direction and a further control program comprising instructions for controlling said working device in at least one cylinder coordinate direction while the working material is fixed in place on said holding fixture.

16. Software according to claim 15, wherein said software utilizes a Wizard comprising questions to be configured by the user in dependence on the type of holding fixture according to either one of claims 13 or 14.
